(19) United States
(12) Patent Application Publication
(10) Pub. No.: US 2011/0231893 A1
(43) Pub. Date: Sep. 22, 2011

(54) Systems and Methods for Mediating Internet Access Provided to End Users

(76) Inventor: Tom C. Tovar, San Francisco, CA (US)

(21) Appl. No.: 12/897,396

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00; G06F 15/16

(52) U.S. Cl. 726/1

(57) ABSTRACT

Systems and methods for creating age based mediation policies and applying those age based mediation policies to Internet service are provided herein. A method for mediating Internet service provided to an end user includes creating an age based mediation policy by receiving information indicative of the end user's age, locating age-appropriate Internet content corresponding to the end user's age and combining the located age-appropriate Internet content with administrator approved Internet content, and applying the age based mediation policy to the Internet service such that only Internet content included in the mediation policy is accessible.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating Internet service, and more specifically, but not by way of limitation, to systems and methods for creating age based mediation policies and applying those age based mediation policies to Internet service.

### SUMMARY OF THE INVENTION

According to exemplary embodiments, the present invention provides a method for mediating Internet service wherein one of the methods comprises: (i) receiving information indicative of the maturity of at least one end user, such as age, by the Internet service; and (ii) applying an age based mediation policy to the Internet service, such that only Internet content included in the age based mediation policy is accessible, wherein the Internet content comprise a combination of appropriate Internet content corresponding to the maturity of the at least one end user and administrator-approved Internet content.

According to other exemplary embodiments, the present invention is directed to a system for an age based mediating Internet service including: (a) a memory for storing a program; (b) a processor for executing the program; (c) a mediation policy module stored in the memory and executable by the processor to receive information indicative of the maturity of at least one end user, such as age, by the Internet service; and (d) an enforcement engine stored in the memory and executable by the processor to apply a mediation policy to the Internet service, such that only Internet content included in the age based mediation policy are accessible, wherein the Internet content comprise a combination of appropriate Internet content corresponding to the age of the at least one end user and administrator-approved Internet content.

According to additional exemplary embodiments, the present invention is directed to a computer readable storage medium having a program embodied thereon, the program executable by a processor to perform a method of mediating Internet service, the method comprising the steps of: (i) receiving information indicative of the maturity of at least one end user, such as age, by the Internet service; and (ii) applying an age based mediation policy to the Internet service, such that only Internet content included in the age based mediation policy are accessible, wherein the Internet content comprise a combination of appropriate Internet content corresponding to the maturity, such as age, of the at least one end user and administrator-approved Internet content.

### BRIEF DESCRIPTION OF THE DRAWINGS

FIG. 1 is a block diagram of an exemplary architecture for practicing embodiments of the present technology that includes a mediation application.

FIG. 2 is a flowchart of an exemplary method for mediating Internet service provided to an end user.

FIG. 3 is an exemplary user interface in the form of a web page describing how an administrator may subscribe to the mediation application.

FIG. 4 is an exemplary user interface in the form of a web page utilized by an administrator to create a mediation policy.

FIG. 5 is an exemplary user interface in the form of a blocking web page that is displayed when an end user attempts to access an inappropriate content.

FIG. 6 is a schematic diagram of a DNS network arrangement.

FIG. 7 is a schematic of an exemplary system for providing variable content control for Internet users.

FIG. 8 illustrates an exemplary computing device that may be used to implement an embodiment of the present technology.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology is directed to systems and methods for mediating Internet service delivered to an end user or group of end users. More specifically, the systems and methods allow for the creation and enforcement of age based mediation policies by applying the age based mediation policies to the Internet service, such that only Internet content included in the mediation policy is accessible to the end users.

Generally speaking, an administrator may create and enforce age based mediation polices for one or more end users that utilize computing devices coupled to an Internet service delivered to a location such as a home, residence place of business or campus. The term “administrator” may include not only individuals, such as parents, but also any individual creating value-based mediation policies regarding the Internet service delivered to end users. It will be understood that an administrator may also be an end user, although end users who are not also administrators may not create or apply mediation policies.

It will be further understood that because of the diversity of computing devices that may connect to the Internet service, the mediation policy may be applied to the Internet service rather than requiring the mediation policy to affect each computing device individually, such as a mediation application resident on each computing device. In various exemplary embodiments an age based mediation policy may also reside as a stand alone application on one or more of the computing devices.

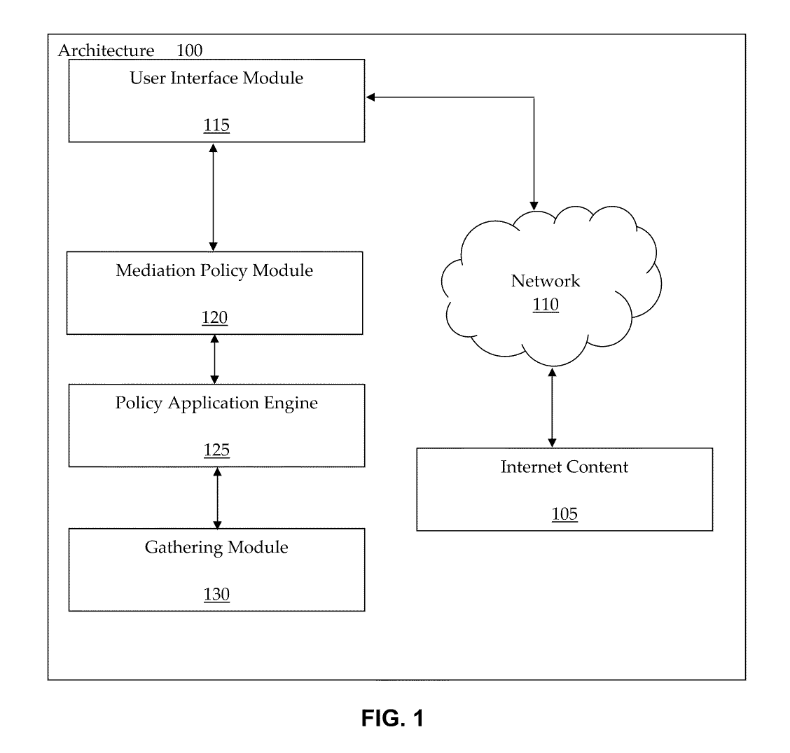

Referring now to FIG. 1, an exemplary architecture 100 of an exemplary mediation policy application resident on a user device 650 is shown. The user device 650 may access Internet content 105 via network 110 utilizing user interfaces generated by the user interface module 115. Generally speaking, the age based mediation policy application allows an administrator to create and apply a customized or “age based” mediation policy that includes a “white” list of content deemed to be age appropriate for one or more end users. The mediation policy, when applied to the Internet service provided to the end user, allows access only to “white” list content in the mediation policy. It is important to note that the mediation policy application does not simply provide blocking mechanisms by masking or enabling network controls, but rather mediates Internet service provided to one or more end users. As used herein, mediating the Internet service may include any of blocking, constraining, enabling, redirecting, promoting, demoting, substituting, obscuring, limiting, interrupting, and restricting all or a portion of the Internet service deemed to be inappropriate for the end users.

The mediation policy application allows for the creation of mediation polices via a user interface 710. A user interface module 115 may generate the user interface 710. The user interface 710 may be implemented in many embodiments, although in various exemplary implementations, the user interface 710 includes a web page adapted to receive mediation information from an administrator.

According to exemplary embodiments, the age based mediation policy application may include a mediation policy module 120, a policy application engine 125, and an optional gathering module 130. It is noteworthy that the mediation policy application 120 may be composed of more or fewer modules and engines (or combinations of the same) and still fall within the scope of the present technology.

In general, the mediation policy module 120 may create mediation policies that are applied to the Internet service by the policy application engine 125. More specifically, the mediation policy module 120 creates a mediation policy by first receiving information indicative of maturity of at least one end user, such as age, from an administrator utilizing the user interface 710. Utilizing the received information, the mediation policy module 120 locates age-appropriate Internet content 105 corresponding to maturity of the at least one end user. It will be understood that the mediation policy may only include information indicative of administrator-defined Internet content.

In various embodiments of the present technology, the mediation policy module 120 locates appropriate Internet content 105 from Internet content records residing in the database. Each Internet content 105 record corresponds to a particular age (e.g., 5, 6, 7, etc.) or other maturity factor and includes Internet content determined to be appropriate for that particular maturity level. It will be understood that Internet content records may be cumulative. For example, an age appropriate Internet content record for end users six years of age includes Internet content 105 determined to be age-appropriate for end users six years of age, but may also include all Internet content 105 determined to be age appropriate for end users less than six years of age.

Internet content records may be populated by executing the optional gathering module 130 to gather Internet content 105 by way of web crawling or spidering the Internet. It will be understood that systems and methods for gathering or locating Internet content 105 (such as web crawling or spidering) are beyond the scope of this application, but would be readily understood and applied to the present disclosure by one of ordinary skill in the art.

Further, the Internet content records may be created leveraging the social production from among several users of the Internet service and imported into the Internet service of the administrator. Such user generated Internet content records may also be modified and republished by the administrator to facilitate collaboration with other administrators of the Internet service.

The mediation policy module 120 is then executed to evaluate Internet content 105 located by the gathering module 130 for appropriateness. Next, the mediation policy module 120 arranges the evaluated Internet content 105 into an Internet content record corresponding to a particular maturity level.

It will be understood that the gathering module 130 may automatically and continuously, or periodically, locate additional Internet content 105 so that the Internet content records may continually evolve/grow over time.

In some instances, the Internet service may be shared by a plurality of end users who may utilize one or more user devices 550 at a particular location, such as a residence. As such, the mediation policy module 120 may be executed to create an “Internet safe-zone” or “white” list of Internet content 105 that applies to all end users or each end user individually.

According to some embodiments, the mediation policy module 120 may receive information indicative of the age of the youngest end user. The mediation policy module 120 then compares the information indicative of the maturity of the youngest end user to Internet content records residing in the database to locate age-appropriate Internet content 105 for the plurality of end users.

Alternatively, it will be understood that the mediation policy module 120 may be executed to create and apply a age based mediation policy for each end user in a more granular or user-specific manner, rather than applying a universal age based mediation policy to all end users based upon the maturity of the youngest end user.

With regard to creating mediation policies that are age based, it will be understood that value systems can vary widely between groups of end users and administrators. For example, a parent (e.g., an administrator) may determine that their seven-year-old child should have access to Internet content 105 that has been evaluated to be inappropriate for a seven year old. As such, the parent may wish to include additional Internet content 105 that the parent deems to be age-appropriate for their seven-year-old child. Allowing parents to include additional administrator-approved Internet content 105 permits the mediation policy application 120 to be flexible, adaptable, and value based.

Therefore, in addition to locating age appropriate Internet content 105 corresponding to the age of the end user, the mediation policy module 120 may receive information indicative of administrator-approved Internet content 105 from the administrator via the user interface 710.

According to exemplary embodiments, a mediation policy may be created to control access to particular websites. An administrator creates the mediation policy for a group of users by inputting age appropriate domains and/or one or more administrator-defined domains. For example, an administrator may enter a domain name (e.g., “www.blockedsite.com”) of a domain, if known. Additionally, the administrator may enter only the name of the domain (e.g., “Blocked Site” or “The Blocked Site”). If the administrator enters a name of a domain, the mediation policy module 120 may evaluate the name to determine if there are one or more domains that correspond to the name. If there is only one domain that corresponds to the name, the mediation policy module 120 may automatically include the evaluated domain in the mediation policy. In contrast, if the mediation policy module 120 locates two or more domains corresponding to the name, the mediation policy module 120 may cause the user interface module 115 to display the located domain names. The administrator may then choose one or more of the located domains displayed by the user interface module 115. The chosen domains are then included in the mediation policy.

The mediation policy module 120 combines the located age appropriate Internet content 105 with the administrator-approved Internet content 105 to create a mediation policy that is age based. These mediation policies may be stored as user records that reside in the database. It will be understood that the database may include one or more databases, which can reside on at least one of the user device 650, the DNS server 610, and the cloud 750 network.

The mediation policy may then be applied to the Internet service, to mediate the Internet service by execution of the policy application engine 125. The policy application engine 125 applies the mediation policy created by the mediation policy module 120 to the Internet service to prevent access to Internet content 105 not included in the mediation policy.

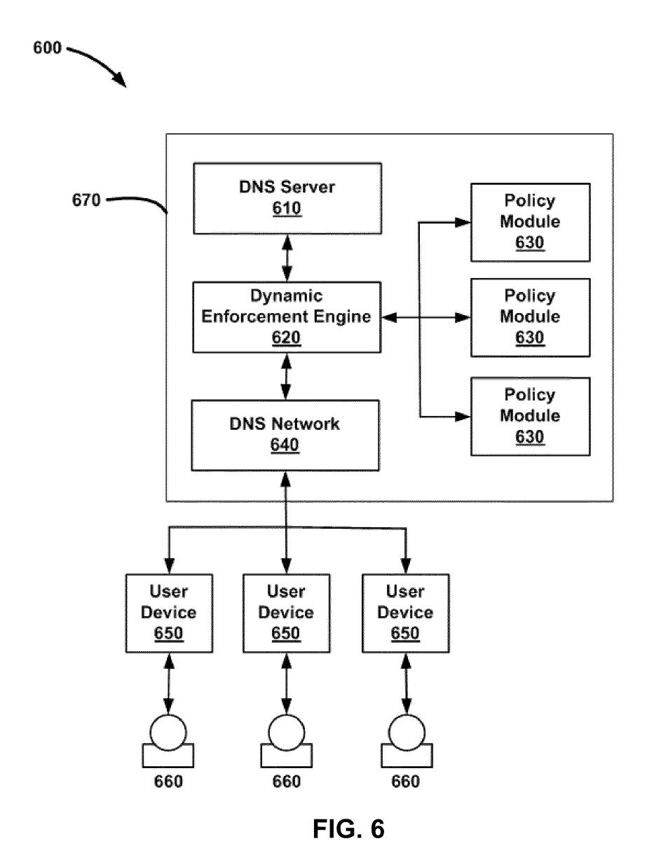

More specifically, if the Internet content 105 is not included in the mediation policy, the policy application engine 125 causes the dynamic enforcement engine 120 to perform at least one of the following actions: (1) prevent the DNS server 610 (FIG. 6) from resolving the Internet content 105 before the Internet service reaches the displays of the user devices 650 (FIG. 6); or (2) prevent the Internet service provider from resolving the Internet content 105 before the Internet service reaches the displays of the user devices 650 (FIG. 6). In the first case, the dynamic enforcement engine 120 may prevent the DNS server 110 from resolving the Internet content 105 by affecting commands and actions occurring on the DNS server 610. It will be understood that the policy application engine 125 may reside on the DNS server 610.

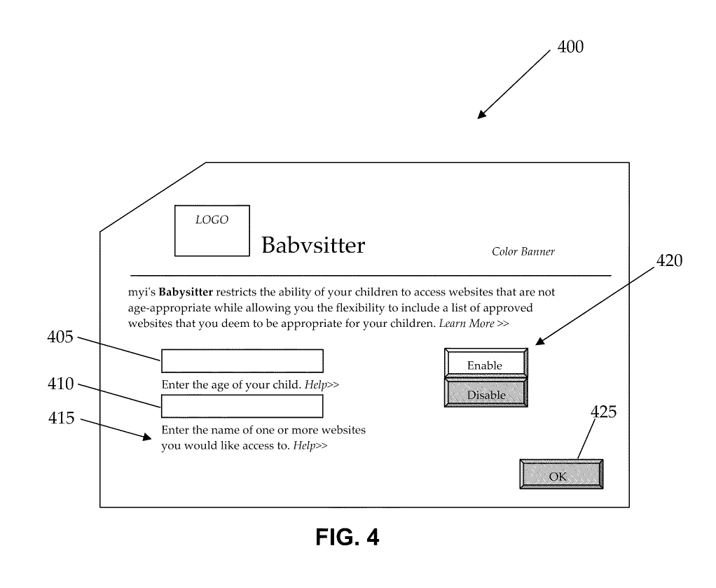

The administrator, via utilization of the user interface 710, may terminate application of the mediation policy to the Internet service at any time. The user interface 710 may include a button (such as an enable/disable button 420 of exemplary FIG. 4) or a check box that can be toggled by the administrator to enable/disable the application of the mediation policy to the Internet service.

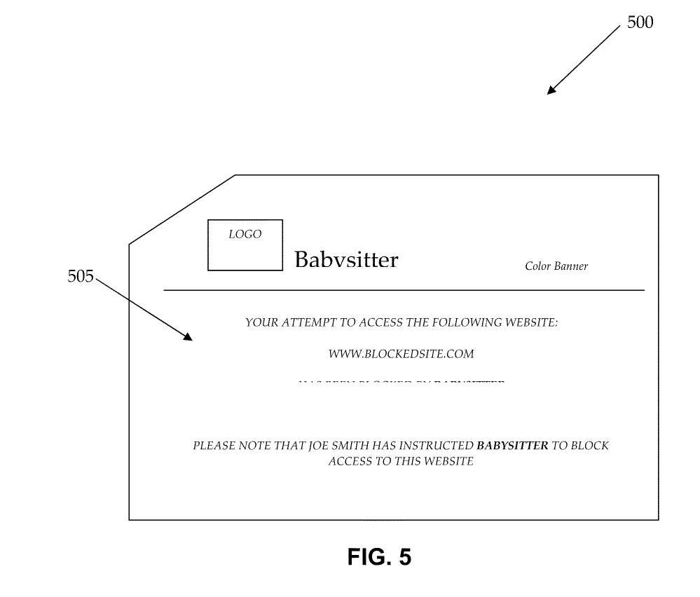

Additionally, if the policy application engine 125 has denied access to Internet content 105, the policy application engine 125 may cause the user interface module 115 to generate a user interface 710 that includes a blocking message. According to various embodiments, the user interface 710 includes a web page notifying the end user that access to the requested Internet content 105 has been denied by the mediation policy application 120. An exemplary blocking page is shown in FIG. 5.

According to other embodiments, the database may be used by the mediation policy module 120 to record and to notify administrators of various data relative to Internet access. The data collected from and provided to the administrators may include records of specific instances when access to a Internet content 105 was blocked, such as when the dynamic enforcement engine 130 prevents resolution of the Internet content 105. Additionally, the mediation policy module 120 may record an aggregate number of times Internet content 105 was blocked in a predetermined amount of time. The data collected may be organized into logs that can be stored in a user record and accessed by the user interface module 115. More specifically, the user interface module 115 may generate a web page (not shown), including log data indicative of the date and time resolutions of Internet content 105 were denied along with information indicative of the Internet content 105.

According to the present disclosure, in some exemplary embodiments the mediation policy may be applied to the Internet service such that only Internet content 105 included in the mediation policy is accessible to end users utilizing a plurality of user devices 150. For example, the mediation policy may be created utilizing a first user device (not shown), such as a desktop computer operated by an administrator. A second user device (also not shown) or additional user devices coupled to the Internet service may only access Internet content 105 included within the mediation policy. It will be understood that the first user device and the second user device are the same.

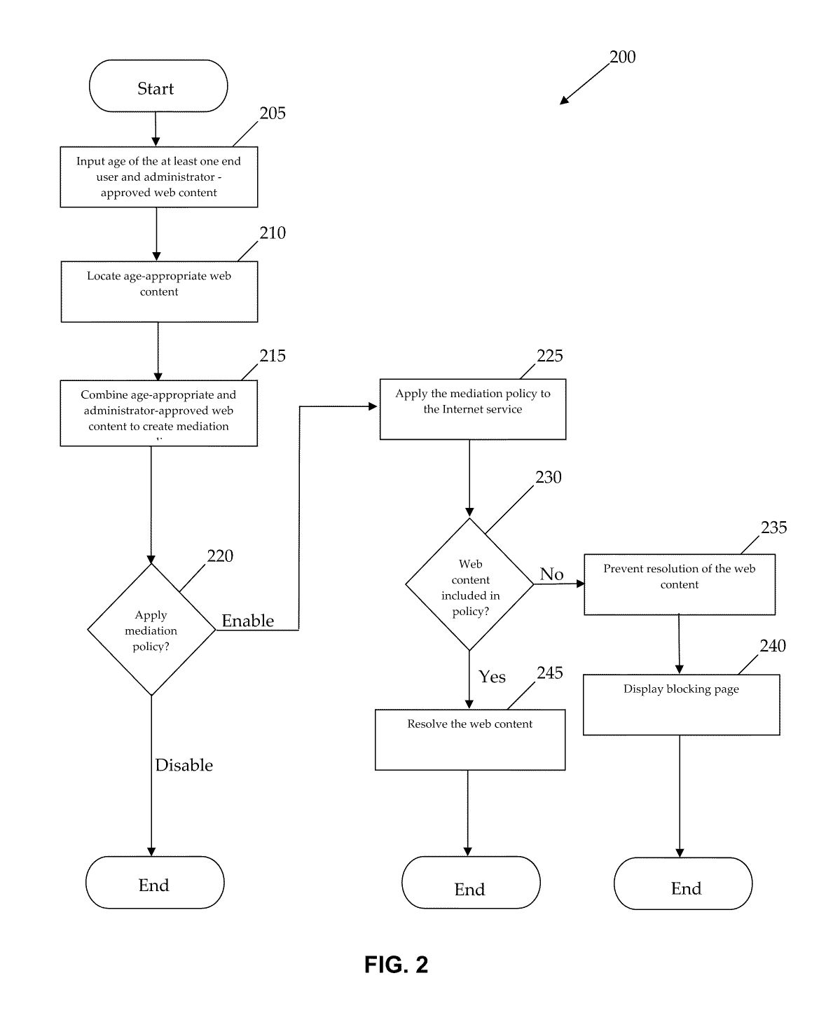

Referring now to FIG. 2, a method 200 for mediating Internet service provided to one or more end users begins with a step 205 of an administrator creating a mediation policy for one or more end users by supplying input via a user interface displayed on the user device. For example, the user interface may display a variety of input fields to the administrator. One or more messages may be displayed on the user interface to elicit input from the administrator. The user interface may then receive input indicative of (i) the age of at least one end user; and/or (ii) information indicative of administrator-approved Internet content. According to various embodiments, receiving information indicative of the maturity of at least one end user may be performed by a DNS server via a user interface.

Input received by the user interface may be utilized by the mediation policy module to create a mediation policy for one or more end users. For example, the administrator inputs information indicative of the age of an end user who is seven years of age. It will be understood that if a plurality of end users utilize a common Internet service, the administrator may input information indicative of the age of the youngest end user. It will further be understood that individual policies may be created for each end user.

A subsequent step 210 includes the mediation policy module locating age-appropriate Internet content corresponding to the age of the end user, which in this case is seven years of age. The mediation policy module locates Internet content age-appropriate for a child who is seven years of age by searching databases associated with the mediation system that include Internet content records having information indicative of age-appropriate Internet content. In this instance, the mediation policy module locates an Internet content record corresponding to an age of seven.

In a next step 215, the mediation policy module combines the located age-appropriate Internet content with information indicative of the administrator-approved Internet content to create a mediation policy for mediating Internet service provided to the end user. The mediation policy may then be stored in a database.

In an additional step 220, the administrator may enable/disable application of the mediation policy to the Internet service. The administrator may enable/disable the application of the mediation policy via a button located on a user interface (such as the enable/disable button 420 of exemplary FIG. 4). If the administrator does not enable the mediation policy, the method terminates.

If the administrator enables application of the mediation policy, the method 200 further includes a step 225 of applying of the mediation policy to the Internet service. More specifically, each application of the mediation policy begins with an end user inputting a request to access Internet content. According to various embodiments, the application of the mediation policy may be performed by a DNS server 610. The end user may input this request via a device connected to the Internet service, such as a browser operating on the user device. In various embodiments, a request includes clicking a hyperlink located on a web page.

In an additional step 230, the policy application engine of the mediation system receives the request and compares the request against the mediation policy. If the policy application engine determines that the Internet content is not included in the mediation policy, the policy application engine causes the dynamic enforcement engine to prevent the DNS server 610 from resolving the Internet content in step 235 by affecting the commands and operations of the DNS server 610.

In addition to preventing resolution of the requested Internet content, the policy application engine may, in step 240, display a notification message to the end user in the form of a blocking web page. It will be understood that the user interface module may generate the blocking web page. The blocking web page may include the following content: a message that the attempt to access the requested Internet content has been denied; a message that the attempt was blocked by the mediation system (which may include the trade name of the system); a message that the administrator has established that the requested Internet content be blocked; and/or any combinations thereof. The method terminates after the dynamic enforcement engine prevents the DNS server from resolving the Internet content and/or the user interface module generates and displays a notification message.

In contrast, if the policy application engine determines that the Internet content is not included in the mediation policy, a step 245 allows the dynamic enforcement engine to cause the DNS server to resolve the Internet content. The Internet content is then provided by the Internet service to the end user via the user device. It will be understood that the method terminates after the DNS server resolves the Internet content.

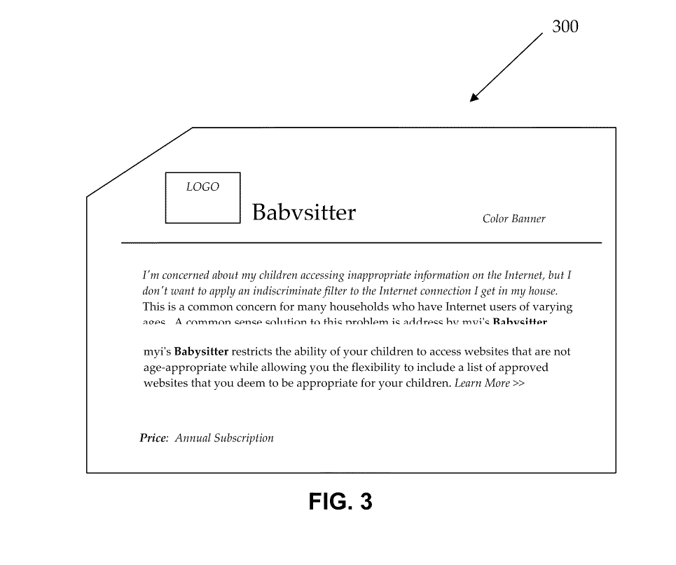

FIG. 3 illustrates an exemplary web page 300 for subscribing to the mediation application. The web page 300 may include (i) content describing the functionality of the application; (ii) the name of the application (“Babysitter”); (iii) a link to more detailed information; and (iv) a price description.

FIG. 4 illustrates an exemplary user interface, which in this instance includes a web page 400 having a first text input box 405 for receiving information indicative of an age of an end user. It will be understood that, rather than a first text input box 405, the user interface 400 may include any number of items utilized to select an age of an end user, such as a drop-down menu. The user interface also includes a second text input box 410 for receiving information indicative of administrator-approved Internet content. Each of the text boxes 405 and 410 may include instructions 415 that elicit input from the administrator. The instructions 415 may be located proximate an appropriate text input box. An enable/disable button(s) 420 is included, allowing an administrator to selectively control application of the mediation policy by enabling/disabling the functionality of the mediation application. Once the administrator is finished inputting information and enabling/disabling application of the mediation policy, the administrator may utilize button 425 to close the web page 400.

FIG. 5 illustrates an exemplary user interface 500, which in this instance includes a blocking web page having content that includes message in the form of a text block 505. The text block 505 includes a message that the attempt to access the requested Internet content has been denied. The text block 505 also includes a message that the attempt was blocked by the mediation system herein described as “Babysitter”. Lastly, the text block 505 includes a message that an administrator requested that the Internet content be blocked.

The systems and methods described above may typically be resident in an Internet service or a DNS network. The systems and methods described may also be implemented in plug-in utilities, gateway devices, cable modems, proxy servers, set top boxes, and network interface devices.

FIG. 6 illustrates an exemplary Internet service system 600, with a DNS server 610, that may be utilized to support the above described systems and methods. The DNS server 610 operates in conjunction with a dynamic enforcement engine 620. The dynamic enforcement engine 620 may operate in conjunction with one or more policy modules 630 to establish any applicable polices at the DNS 610 level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

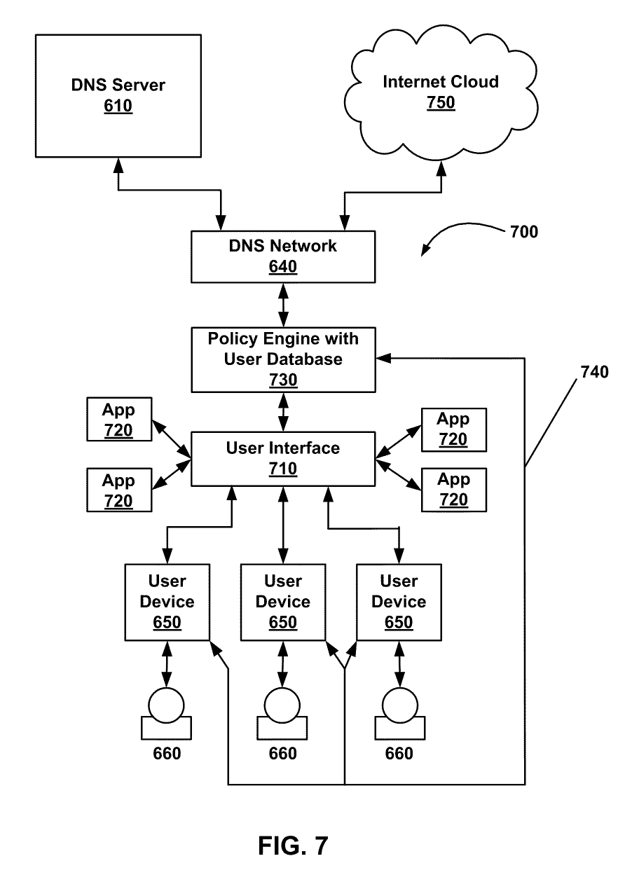

FIG. 7 shows a schematic layout of an exemplary system 700 for implementing direct and variable end user control. FIG. 7 illustrates that the system 700 may operate installed on a DNS server 610, or with a cloud 750 based installation.

The system 700 utilizes a user interface 710. The user interface 710 may be implemented in many embodiments. One specific implementation of the user interface 710 is as a web page.

The user interface 710 may be accessed by one or more user devices 650 operated by the users 660. The user interface 710 may be accessed though a gateway user device 650 available to the users 660. Suitable user devices 650 include but are not limited to desktops, PCs, laptops, notebooks, gaming devices, music players, Smartphones, automobile computer systems, and Internet enabled TVs. The system 700 may also be accessed and controlled remotely through a mobile user device 650, such as a Smartphone or specialized Internet access device. A Smartphone may be defined as a phone with computing capability. A Smartphone may provide the user 660 with Internet access.

The user interface 710 provides a mechanism for one or more authorized users 660 to establish content policy for the Internet service. The user interface 710 operates between the user devices 650 present in the system 700 and the DNS service 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may mediate access to specific sites. The policy applications 720 may also limit the time of day when users or selected users 660 may access certain sites. The policy applications 720 may also manage and analyze duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when sites are accessed. The policy applications 720 may also provide notification of frequency and duration of access of designated sites. The policy applications 720 may also be used to observe, substitute, enable, redirect users, to influence behaviour desired from the users by a system administrator, etc. The policy applications 720 may redirect users from a non-favored site to another site. The policy applications 720 may also collect and transmit data characteristic of Internet use.

Access policies supplied by the policy applications 720 may apply to all users 660 of the system 700, or the access policies may be specific to individual users or groups of users 660. The policy applications 720 may be discrete, single purpose applications. As used herein, mediating the Internet service may include any of blocking, constraining, enabling, redirecting, promoting, demoting, substituting, obscuring, limiting, interrupting.

The policy applications 720 provide the users 660 with a mechanism to take various actions relative to their Internet service. The policy applications 720 also allow the users 660 to establish policy that is then implemented by a dynamic policy engine 730 that uses a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, etc.

It should also be noted that following an initial setup through the user interface 710 of the policy engine 730, a direct access 740 enforcement loop may be established between the policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 720 may be separately configurable as well. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710, to the policy enforcement engine 730. A second data path 740 may be utilized following the establishment of a set of policies for the system 700. The second data path 740 flows directly between the user device(s) 650 and the policy engine 730. Multiple sets of enforcement policies may be established and saved within the system 700 and implemented selectively by the users 660.

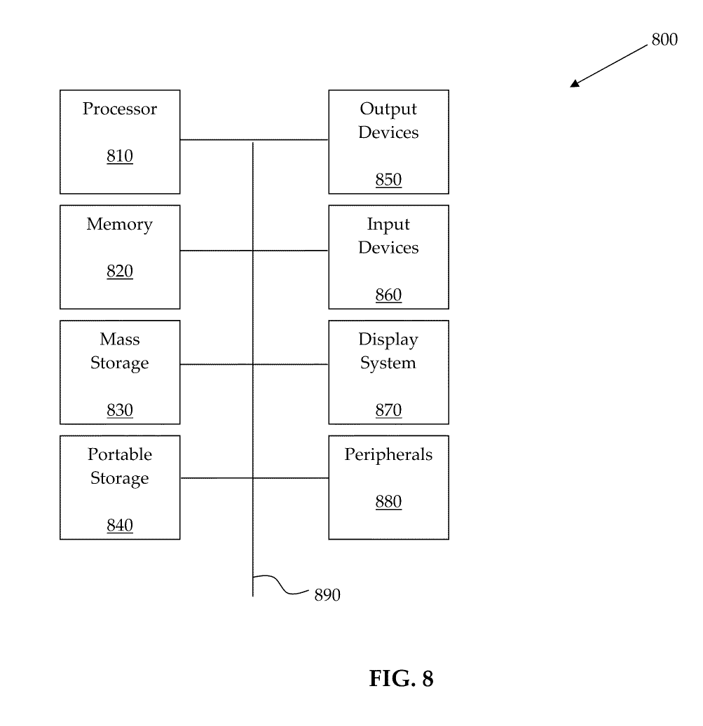

FIG. 8 illustrates an exemplary computing system 800 that may be used to implement an embodiment of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service, and vice versa.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an Internet access user device and may include but not be limited to one or more of web sites, domains, web pages, web addresses, hyperlinks, URLs, any text, pictures, and/or media (such as video, audio, and any combination of audio and video) provided or displayed on a web page, and any combination thereof. As used herein, mediating the Internet service may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating Internet service, the method comprising:
receiving information via the user interface indicative of the age of at least one end user of the Internet service; and
applying an age based mediation policy to the Internet service, such that only Internet content included in the mediation policy is accessible at a selected location, wherein the Internet content comprises at least one age-appropriate Internet content corresponding to the age of the at least one end user and administrator-approved Internet content.

2. The method of claim 1, wherein the information indicative of the age of the at least one end user is received from a first computing device coupled to the Internet service and the mediation policy is applied to the Internet service such that only Internet content included in the mediation policy is accessible to any computing device coupled to the Internet service.

3. The method of claim 2, wherein the first computing device and the second computing device are the same.

4. The method of claim 1, wherein at least one element of the mediation policy is resident on a DNS server.

5. The method of claim 1, wherein at least one element of the mediation policy is enforced by the DNS server.

6. The method of claim 1, wherein the administrator specifies different mediation polices for different locations.

7. The method of claim 1, further comprising creating a mediation policy by:
locating age-appropriate Internet content corresponding to the age of the at least one end user;
combining the located age-appropriate Internet content with administrator-approved Internet content; and
configuring mediation policies to allow access to combined Internet content.

8. The method of claim 7, wherein creating a mediation policy further includes:
evaluating the Internet content for age-appropriateness;
grouping the Internet content into Internet content records according to age; and
locating age-appropriate Internet content from one or more Internet content records corresponding the age of the at least one end user.

9. The method of claim 7, wherein creating a mediation policy includes creating a mediation policy for a plurality of end users sharing a common Internet service by:
receiving information indicative of the ages of the plurality of end users;
locating age-appropriate Internet content for the plurality of end users; and
combining the located age-appropriate Internet content with administrator-approved Internet content.

10. The method of claim 7, further comprising the step of updating the mediation policy by:
locating additional Internet content;
evaluating the additional Internet content for age-appropriateness; and
adding the evaluated Internet content to the mediation policy when the Internet content is determined to be age-appropriate for the at least one end user.

11. The method of claim 1, wherein the mediation policy further includes locating Internet content determined to be age-appropriate for end users younger than the at least one end user.

12. The method of claim 1, wherein applying the mediation policy to the Internet service includes:
receiving a request to access Internet content from an originating computing device coupled to the Internet service;
comparing the requested Internet content to the mediation policy; and
preventing access to the requested Internet content by the Internet service if the requested Internet content is not included in the mediation policy.

13. The method of claim 12, wherein blocking includes preventing access to the requested Internet content performed by an Internet service provider if the requested Internet content is not included in the mediation policy.

14. The method of claim 12, further comprising presenting a notification to the originating computing device that access to the Internet content is prohibited by the mediation policy.

15. The method of claim 12, wherein blocking includes preventing access to the requested Internet content by the Internet service if the requested Internet content is not included in the mediation policy.

16. The method of claim 1, further comprising terminating execution of the method by receiving a request to terminate from an administrator.

17. The method of claim 1, wherein a unique mediation policy is applied to each user based on the age of the user.

18. The method of claim 1, wherein the mediation policy is created by the administrator.

19. The method of claim 1, wherein the mediation policy is created by a collaborative effort from more than one user.

20. The method of claim 19, wherein at least one user is not a user of the network to which the mediation policy is applied.

21. The method of claim 1, wherein at least a portion of the Internet service is resident on a user device.

22. A system for mediating Internet service, the system comprising:
a memory for storing a program;
a processor for executing the program;
a mediation policy module stored in the memory and executable by the processor to receive information indicative of an age of at least one end user; and
an enforcement engine stored in the memory and executable by the processor to apply an age based mediation policy to the Internet service such that only Internet content included in the mediation policy is accessible, wherein the Internet content comprises at least one of age-appropriate Internet content corresponding to the age of the at least one end user and administrator-approved Internet content.

23. The system of claim 22, further comprising a gathering module stored in the memory and executable by the processor to automatically and continuously locate additional Internet content.

24. The system of claim 23, wherein the additional Internet content located by the gathering module is evaluated by the mediation policy module for age appropriateness and added to an Internet content record corresponding to a particular age.

25. The system of claim 22, wherein the enforcement engine is configured to:
receive a request to access Internet content from a computing device couple to the Internet service;
compare the requested Internet content to the mediation policy; and
block a resolution performed by the DNS server if the requested Internet content is not included in the mediation policy.

26. The system of claim 25, wherein the request includes information indicative of at least one of an Internet content and an Internet protocol address.

27. The system of claim 25, wherein the enforcement engine outputs notification to the computing device that access to the Internet content has been blocked.

28. The system of claim 27, wherein notification includes a blocking web page created by a user interface module.

29. The system of claim 22, wherein the entire system is cloud based.

30. The system of claim 22, wherein the mediation policy is created by the administrator.

31. The system of claim 22, wherein the mediation policy is produced by groups of users of the Internet service.

32. The system of claim 31, wherein at least one of the users producing the mediation policy is not a user of the network to which the mediation policy is applied.

33. The system of claim 22, wherein a DNS server initiates a request that is then further processed by the Internet service.

34. The system of claim 22, wherein a history of access to Internet content is stored and is accessible for processing, analysis, or reporting.

35. The system of claim 22, wherein a history of notifications is stored and is accessible for processing, analysis, or reporting.

36. A method for mediating Internet service, the method comprising:
receiving via a user interface information indicative of the age of at least one end user of the Internet service; and
applying via a DNS server an age based mediation policy to the Internet service, such that only Internet content included in the mediation policy is accessible, wherein the Internet content comprises at least one age-appropriate Internet content corresponding to the age of the at least one end user and administrator approved Internet content.

37. The method of claim 36, wherein the information indicative of the age of the at least one end user is received from a first computing device coupled to the Internet service and the mediation policy is applied to the Internet service via the DNS server such that only Internet content included in the mediation policy is accessible to any computing device coupled to the Internet service.

38. The method of claim 36, wherein at least one element of the mediation policy is resident on the Internet service.

39. The method of claim 36, wherein at least one element of the mediation policy is enforced by the Internet service.

40. The method of claim 36, wherein the administrator specifies different mediation polices for different locations.

41. The method of claim 36, further comprising creating a mediation policy by:
locating age-appropriate Internet content corresponding to the age of the at least one end user;
combining the located age-appropriate Internet content with administrator-approved Internet content; and
configuring mediation policies in the DNS server to allow access to combined Internet content.

42. The method of claim 41, wherein creating a mediation policy further includes:
evaluating the Internet content for age-appropriateness;
grouping the Internet content into Internet content records in the DNS server according to age; and
locating age-appropriate Internet content from one or more Internet content records corresponding the age of the at least one end user.

43. The method of claim 41, wherein creating a mediation policy includes creating a mediation policy in the DNS server for a plurality of end users sharing a common Internet service by:
receiving information indicative of the ages of the plurality of end users;
locating age-appropriate Internet content for the plurality of end users;
combining the located age-appropriate Internet content with administrator-approved Internet content; and
configuring mediation polices to allow access to combined Internet content.

44. The method of claim 41, further comprising the step of updating the mediation policy by:
locating additional Internet content;
evaluating the additional Internet content for age-appropriateness; and
adding the evaluated Internet content to the mediation policy in the DNS server when the Internet content is determined to be age-appropriate for the at least one end user.

45. The method of claim 36, wherein the mediation policy further includes locating Internet content determined to be age-appropriate for end users younger than the at least one end user.

46. The method of claim 36, wherein applying the mediation policy to the Internet service includes:
receiving a request by the DNS server to access Internet content from an originating computing device coupled to the Internet service;
comparing the requested Internet content in the DNS server to the mediation policy; and
preventing access to the requested Internet content by the Internet service if the requested Internet content is not included in the mediation policy.

47. The method of claim 46, wherein applying the mediation policy further includes preventing access to the requested Internet content by the DNS server operated by an Internet service provider if the requested Internet content is not included in the mediation policy.

48. The method of claim 46, wherein applying the mediation policy further includes preventing access to the requested Internet content performed by the DNS server if the requested Internet content is not included in the mediation policy.

49. The method of claim 46, further comprising presenting a notification to the originating computing device that access to the Internet content is prohibited by the mediation policy.

50. The method of claim 40, further comprising terminating execution of the method by receiving a request to terminate from an administrator.

51. The method of claim 38, wherein a unique mediation policy based on the age of the user is applied to each user.

52. The method of claim 38, wherein the mediation policy is created by an administrator.

53. The method of claim 38, wherein the mediation policy is created by a collaborative effort from more than one entity.

54. The method of claim 38, wherein at least one entity is not a user of the network to which the mediation policy is applied.

55. The method of claim 38, wherein at least a portion of the Internet service is resident on a user device.

56. A system for mediating Internet service, the system comprising:
a memory for storing a program;
a processor for executing the program;
a mediation policy module stored in the memory and executable by the processor to receive information via a DNS server indicative of an age of at least one end user; and
an enforcement engine stored in the memory and executable by the processor to apply a mediation policy to the Internet service via the DNS server such that only Internet content included in the mediation policy is accessible, wherein the Internet content comprises at least one of age-appropriate Internet content corresponding to the age of the at least one end user and administrator-approved Internet content.

57. The system of claim 56, further comprising a gathering module stored in the memory and executable by the processor to automatically and continuously locate additional Internet content.

58. The system of claim 57, wherein the additional Internet content located by the gathering module is evaluated by the mediation policy module for age appropriateness and added to an Internet content record corresponding to a particular age.

59. The system of claim 56, wherein the enforcement engine is configured to:
receive a request to access Internet content from a computing device couple to the Internet service;
compare the requested Internet content to the mediation policy; and
block a resolution performed by the DNS server if the requested Internet content is not included in the mediation policy.

60. The system of claim 59, wherein the request includes information indicative of at least one of an Internet content and an Internet protocol address.

61. The system of claim 59, wherein the enforcement engine outputs notification to the computing device that access to the Internet content has been blocked.

62. The system of claim 61, wherein notification includes a blocking web page created by a user interface module.

63. The system of claim 56, wherein the entire system is cloud based.

64. The system of claim 56, wherein the mediation policy is created by the administrator.

65. The system of claim 56, wherein the mediation policy socially produced by groups of users of the Internet service.

66. The system of claim 56, wherein a DNS server initiates a request that is then further processed by the Internet service.

67. The system of claim 56, wherein a history of access to Internet content is stored and is accessible for processing, analysis, or reporting.

68. The system of claim 56, wherein a history of notifications is stored and is accessible for processing, analysis, or reporting.

69. The system of claim 56, wherein at least a portion of the Internet service is resident on a user device.

70. A non-transitory computer readable storage medium having a program embodied thereon, the program executable by a processor in a computing device to perform a method of mediating Internet service, the method comprising:
receiving information indicative of an age of at least one end user by the Internet service; and
applying a mediation policy to the Internet service such that only Internet content included in the mediation policy are accessible, wherein the Internet content comprise a combination of age-appropriate Internet content corresponding to the age of the at least one end user and administrator-approved Internet content.

71. The computer readable storage medium of claim 70, wherein applying the mediation policy includes:
receiving a request to access an Internet content from a computing device coupled to the Internet service;
comparing the requested Internet content to the mediation policy; and
blocking a resolution performed by the Internet service if the requested Internet content is not included in the mediation policy.

72. The computer readable storage medium of claim 70, wherein blocking includes blocking a resolution performed by an Internet service provider if the requested Internet content is not included in the mediation policy.

73. A method for mediating Internet service, the method comprising:
receiving information regarding an age of at least one end user by an Internet service via a communications interface of a computing device, the computing device coupled to the Internet service; and
executing instructions stored in memory by a processor to apply a mediation policy to the Internet service, such that only Internet content included in the mediation policy is accessible to the computing device, the Internet content comprising a combination of age-appropriate Internet content corresponding to the age of the at least one end user and administrator-approved Internet content.

74. A method for mediating Internet service, the method comprising:
establishing a user interface between an end user and an Internet service;
receiving information indicative of the age of at least one end user by the Internet service via the user interface; and
applying a mediation policy to the Internet service such that only Internet content included in the mediation policy are accessible, wherein the Internet content comprise a combination of age-appropriate Internet content corresponding to the age of the at least one end user and administrator-approved Internet content.

75. The method of claim 74, wherein the user interface includes a web page comprising (i) at least one input component for receiving information indicative of the age of at least one end user; (ii) at least one input component for receiving information indicative of administrator-approved Internet content; and (iii) a selection component for selectively applying the mediation policy to the Internet service.

76. The method of claim 75, wherein the at least one input component includes a text input box.

77. The method of claim 74, wherein the at least one input component includes a dropdown menu having a plurality of selections corresponding to different ages.

78. The method of claim 74, wherein the at least one input component for receiving information indicative of administrator-approved includes a text input box.

79. The method of claim 78, wherein input received by the text input box is evaluated to locate Internet content that corresponds to the received input.

80. The method of claim 79, wherein the located Internet content is displayed via the user interface and the administrator selects one or more of the determined Internet content to add to the mediation policy as administrator-approved Internet content.
